(19) United States
(12) Patent Application Publication
(10) Pub. No.: US 2010/0050531 A1
(43) Pub. Date: Mar. 4, 2010

(54) DEVICE FOR FIXING DRIVE ELEMENTS

(76) Inventors: Harald Koellner, Altenstadt (DE); Ryu Kwang-Won, Gyeonggi-do (KR); Jang Bong-Jun, Gyeonggi-do (KR)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(21) Appl. No.: 12/520,776

(22) PCT Filed: Dec. 20, 2007
(86) PCT No.: PCT/EP07/11489

§ 371 Date: Nov. 5, 2009

(30) Foreign Application Priority Data
Dec. 22, 2006 (DE) 10-2006-660.5

(51) Int. Cl. E05F 11/38; E06B 3/00

(52) U.S. Cl. 49/360; 49/324; 49/506

(57) ABSTRACT

A device for use in a window hoisting device includes a base element and a drum that can be connected to the base element. A drive element can be wound around the drum such that ends of the drive element protrude from the drum. The device includes at least one securing element that is configured to secure an end of the drive element.

### CROSS-REFERENCE TO RELATED APPLICATIONS

The present application is a national phase application of PCT application PCT/EP2007/011489 filed pursuant to 35 U.S.C. §371, which claims priority to DE 10 2006 062 660.5 filed Dec. 22, 2006. Both applications are incorporated herein by reference in their entirety.

### TECHNICAL FIELD

The invention relates to a device which has a drum and a base element, as are frequently used in window lifters in automotive vehicles, the device allowing fixing of the drive elements.

### BACKGROUND

Because of increasing modularization in automobile construction, individual components are frequently manufactured at different locations and then transported to a single location in order to assemble these different elements. This modularization is also widespread in the assembly of window lifters on a door element.

Before a window lifter is attached to a door module, the window lifting mechanism is assembled at a different location. A windable drive element, such as a cable or a wire, is wound onto a drum and the drum is subsequently placed on a base element.

In the state of the art, mechanisms are known with which a drive element wound onto the drum is secured on the drum so that, during transport of the wound-up drum to the base element, the drive element cannot escape from the drum. After assembly of the drum with the base element, the assembled device is prepared for transport so that it can be subsequently screwed together with the door module. Although the drive elements cannot escape from the drum because of various mechanisms, they protrude from the drum since the complete drive element cannot be wound onto the drum since the drive element still requires to be installed in the completed window lifting mechanism. These freely hanging ends of the drive elements constitute problems during transport and subsequently in the assembly of the window lifting mechanism.

The presence of detachable securing elements is likewise known from DE 4016009 C1. The disadvantage thereby exists that the securing elements can be lost and have a complicated construction.

### SUMMARY OF THE INVENTION

The present invention is directed to constructing a window lifting mechanism which has a simple construction and, at the same time, resolves the problems with the freely hanging ends of the drive elements which arise during transport and assembly of the window lifting unit by securing the drive elements.

In an embodiment, the invention is a device, in particular a window lifting unit, that has a base element and a drum. The drum is able to be connected to the base element and can receive at least one windable drive element, the drive elements being able to be wound up and unwound and having ends which protrude from the drum. At least one securing element is configured for securing a portion of the drive elements which protrude from the drum, the securing element being configured at a spacing from the drum.

By means of a device of this type, the drive elements are fixed between the drum take-off thereof and the securing element which is at a spacing from the drum such that the drive elements meet the requirements which are required during transport of the above-mentioned device and the assembly with the door unit. The configuration and position of the securing elements is thereby dependent both upon the material properties of the drive elements and upon the special requirements in the production chain.

The securing elements are produced as recesses in the base element. In another embodiment of the invention, the recesses are provided in material portions that extend directly out of the base element. This has the advantage in particular that securing becomes possible by wedging with simultaneous saving in material, the configuration and form of the recess being able to be produced, for example in the form of a straight line or a cross. In particular the cruciform recess shape offers a frictional fixing possibility.

The base element has the recesses. Because no further components are present for fixing the drive elements, the base plates can be produced in one piece which reduces the production costs.

The recesses can be disposed directly on the base element or at material tongues extending from the base element. They can also be produced between an arch that protrudes from the base plate and is connected integrally to the base plate, providing a gap between the arch and the base plate.

The geometry of the recesses can be a straight or curved line or advantageously have a cruciform or “T” shape.

An embodiment of the invention resides in the securing element allowing a frictional securing or fixing of the drive element, the fixing being able to be achieved here by various possibilities. Fixing by wedging, jamming or clamping in the recess is advantageous, as a result of which the drive elements can be connected as often as desired to the securing element and be removed again.

It is thereby advantageous if the recess tapers from the open to the closed end and/or tapers from an upper side to a lower side. Inserting the drive elements into the recesses or removing the drive elements from the recesses can therefore be implemented in a particularly simple manner.

In another embodiment of the invention, a separate securing element is present for each end of a drive element protruding out of the drum. This embodiment involves advantages during the assembly process since the ends of the drive elements are pre-sorted already by the separated securing elements. This applies in particular to the case where only one drive element is wound onto the drum so that two ends, which can be fixed by precisely two securing elements, protrude from the drum.

In another embodiment of the invention, the securing elements are disposed respectively, one situated opposite the other, relative to an axis of symmetry of the base element. Since the device is used mainly in a window lifting unit of an automotive vehicle and, in the latter, the ends of the drive elements are guided further usually via a roller system respectively in a different direction and the base element is recessed in the vehicle door corresponding to the subsequent installation directions of the drive elements, it makes sense to fit the securing elements, as described above, along the axis of symmetry of the base element one situated opposite the other in order thus to facilitate installation of the drive elements due to the position of the securing elements.

In another embodiment, the securing element is formed on the base plate of the base element, forming an arch either from the base plate itself or from an extra component, a narrow gap being present as a recess between the arch and the base plate of the base element. Wedging the drive elements in the gap between the arch and the base plate can provide a good fixing or securing of the ends of the drive elements.

A further possibility for configuring the securing elements is attaching an additional clip to the base element.

In an embodiment of the invention, the drive elements are configured as a cable made of metal or plastic material or as a wire.

In an embodiment of the invention, the base element is produced from plastic material or metal, in particular in one operating step from one material. Injection molding technology or similar methods are advantageous as production methods.

An advantageous use of the cited invention is to use it as part of a window lifting device which is used in a vehicle or an automotive vehicle.

A device as described herein can be transported and attached to a door module. In a first step, the drive elements are wound onto the drum and the wound-up drum is connected to the base element. In a second step, the ends of the drive elements which hang from the drum are wedged into the recesses of the securing elements of the device. The thus secured devices are thereupon transported to the location of assembly with the door module. In a further step, the thus secured device is connected to the door module. In some embodiments, the drive elements are positioned by the securing elements such that attaching the device to the door module, e.g. by screwing or insertion, is not impeded by the drive elements. This can be such that the drive elements cannot hang freely in any manner along the device because of the position of the securing elements but drop therefrom only laterally at a spacing.

In a further step, the drive elements are removed from the recesses of the securing elements and the drive elements can come into operational connection with other parts of the window lifting device.

In some embodiments, because of the known position of the securing elements, insertion of the drive elements into the securing elements and removal of the drive elements from the securing elements is supplied by an automatic machine or robot.

### BRIEF DESCRIPTION OF THE FIGURES

FIG. 1 shows a wire drum with wound-up drive element and a base element with securing elements that are produced as gaps.

FIG. 2 shows a drum with wound-up drive element and a base element with securing elements that are produced as recesses.

FIG. 3 shows a perspective illustration of an embodiment of the base element, the securing elements being produced as material tongues, which protrude from the base element, with recesses.

### DETAILED DESCRIPTION

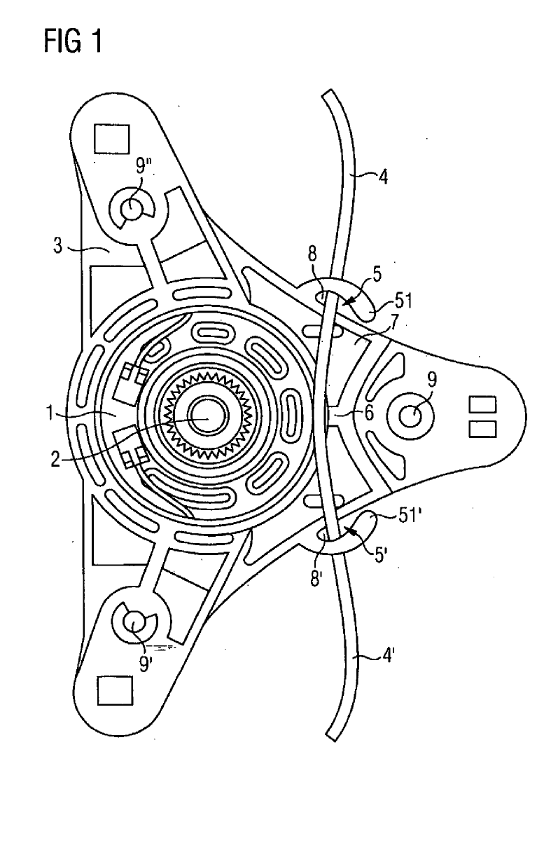

An embodiment of the device according to the invention is represented in FIG. 1. In FIG. 1, a drum 1 is connected via a connecting element 2 to a base element 3. A drive element that is configured as a wire cable is wound up onto the drum 1 such that two drive elements 4, 4′ extend from the drum 1.

Furthermore, two securing elements 5, 5′ which fix the drive element 4, 4′ are shown.

A device as seen in FIG. 1 is used in the window lifting devices of automotive vehicles. The base element is attached directly to a door module or a door interior panel or constructed with other further parts of the window lifting device before the latter is attached then to the door module or the door interior panel. In the case of direct attachment to a door module, the drive elements 4, 4′ are brought into operational connection with further components via a roller system so that, when assembly of the entire window lifting device is complete, a window can be opened and closed either manually or automatically.

It can be seen that the securing elements are configured at a spacing from the drum and hence a part of the drive element is fixed between a take-off 6 of the drive element of the drum 1 and the securing elements 5, 5′. In this embodiment, only one drive element with two ends 4, 4′ which protrude from the drum is visible. In some embodiments, a plurality of drive elements are wound onto a drum and a plurality of ends protrude from the drum. In some embodiments, the securing elements 5, 5′ respectively can fix a plurality of drive elements, however it is also conceivable that a plurality of securing elements exist in addition to the represented securing elements 5, 5′ in order to produce better sorting of the drive elements. In some embodiments, only one securing element is included.

The securing elements 5, 5′ are configured here as arches extending from a base plate 7 of the base element 3. The arches 5, 5′ are, in the illustrated embodiment, formed out of the base plate 7 of the base element in one piece.

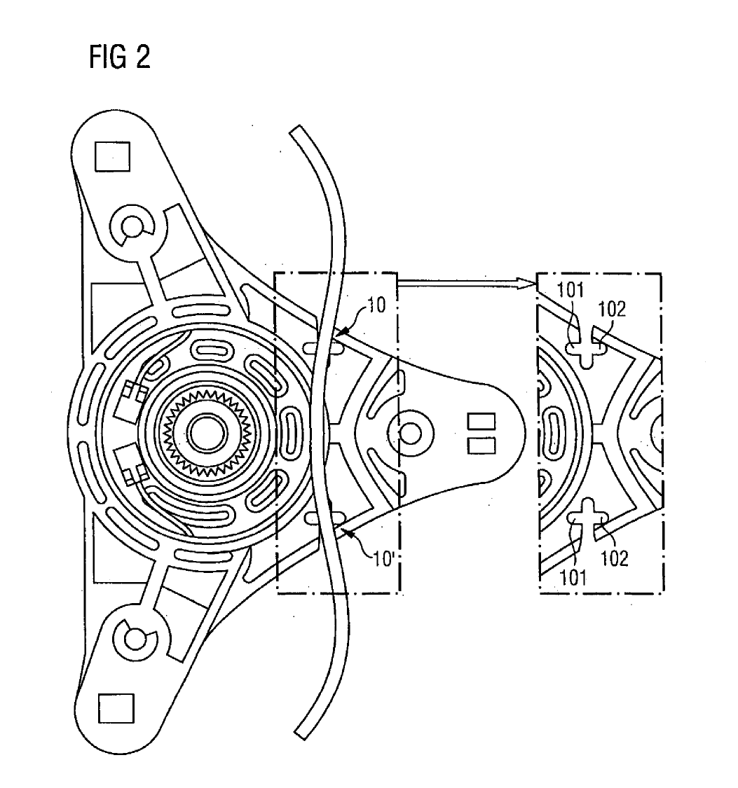

In some embodiments, the arches 5, 5′ may be produced using additional components that are connected directly or indirectly to the base element 3. The securing elements 5, 5′ fix the ends of the drive element 4, 4′ by wedging the drive elements in the recesses 8, 8′ which are configured as gaps and are produced between the arches 5, 5′ and base plate 7 of the base element 3. The shape and size of the gaps 8, 8′ is dependent upon the strength of the desired fixing of the ends of the drive elements 4, 4′ and also upon the material of the drive elements 4, 4′. The cruciform configurations of FIG. 2 are also useful. In some embodiments, the shape of the arch for a drive element configured as a wire can be different from that for a drive element configured as a cable, on the basis of the different stiffnesses and elasticities thereof.

The principle of wedging remains the same in both cases. In order to move the ends of the drive elements 4, 4′ into the fixed positions in the gaps in 8, 8′, the drive elements 4, 4′ are pressed into the gaps 8, 8′ starting from outside between the ends 51, 51′ of the arches and the base plate 7 of the base element 3. In some embodiments, the spacing between the ends 51, 51′ of the arches and the base plate of the base element can be smaller than, equal to or greater than the height of the gaps 8, 8′. In the illustrated embodiment, the spacing between the ends of the arch 51, 51′ and the base plate 7 of the base element 3 is smaller and the arch provides a gap which is higher than the spacing of the ends (51, 51′) from the base plate 7.

In some embodiments, the securing elements 5, 5′ are configured such that, during assembly of the device to for example a door module, the drive elements, in the attachment of the device on the door module by screws which are inserted into the boring holes 9, do not hang in the region 3 in which the borings 9 are located. An assembler or an automatic machine which undertakes this attachment saves time since he/it does not require to keep the drive elements at a distance from the borings 9.

FIG. 2 shows a device analogous to FIG. 1, however with a different embodiment of the securing elements 10 and 10′. Otherwise, the individual elements of FIG. 2 are configured the same as the elements in FIG. 1 and are described in particular with the same numbers. The securing elements 10, 10′ are formed as recesses in the base element 3. In the illustrated embodiment, the recesses are cruciform in shape (cross-shaped). This represents an advantageous embodiment of the recesses since the ends of the drive elements 4, 4′ are wedged, jammed or clamped in one of the side arms 101, 101′ or 102, 102′ of the recesses 10, 10′, the type of fixing in turn being dependent upon the material properties of the drive elements. It is possible to fit a cover-like construction on the recess openings 11, 11′ which closes the recess after introduction of the drive elements 4, 4′ into the recesses 10, 10′. A clip-like embodiment of the recesses 10, 10′, in which the oppositely situated walls of the recesses 11, 11′ can be opened and closed, can also be produced in order to fix the drive element 4, 4′ in the recesses.

The recesses usually have an open end in order to facilitate introduction of the drive elements. Furthermore, it is advantageous if the recesses taper conically in order to achieve or to assist the wedging effect.

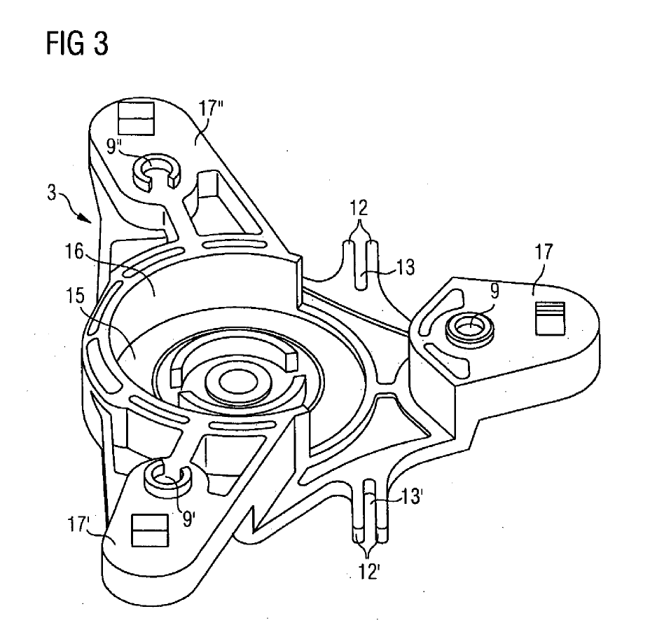

FIG. 3 shows a perspective illustration of the base element 3 . In this embodiment, the base element 3 includes material tongues 12, 12′ that protrude from the base plate 7 and that each have one recess 13, 13′. As a further detail of the recesses 13, 13′, the ends of the recesses 131, 131′ fall diagonally from the upper side of the base element 3 towards the lower side of the base part and the length of the recess 13, 13′ on the upper side of the base element is longer than on the lower side of the base element.

In the illustrated embodiment, the base element includes a surface 15 that is configured to receive a drum such as the drum 1. An annular wall 16 forms a delimitation on the basis of which a drive element can be retained securely on the wound-up drum.

In some embodiments, the edge surface 16 does not exist and the arms 17, 17′, 17″ including the bore holes 9 are situated essentially in the same plane as the base plate 7 of the base element 3. It is obvious that the base plate 7 of the base element 3 can also be part of the base element 3.

FIGS. 1 to 3 show various embodiments of the device described herein, which substantially facilitates the transport and assembly to a door module.

The essence of the invention fulfils the object of making available a simple device which eliminates the problems during transport and assembly to the door module on the basis of the drive elements, with the help of securing elements in the form of recesses which are connected securely and integrally to the base element.

1-15. (canceled)

16. A device configured for use in a window lifting unit, the device comprising:
a base element including a base plate;
a drum configured to be connected to the base element, the drum including a drum take-off;
a windable drive element configured to be wound up on the drum, the windable drive element having drive element ends that protrude from the drum when the windable drive element is wound up on the drum; and
a securing element configured to secure the windable drive element ends protruding from the drum such that a direction of the drive element is fixed, the securing element disposed at a spacing from the drum, the securing element comprising a recess formed within the base element.

17. The device of claim 16, wherein the base element comprises a material tongue extending outwardly from the base plate, and the recess is disposed between the material portion and the base plate.

18. The device of claim 17, wherein the material portion forms an arch extending from the base plate, and wherein the recess is a gap between the arch and the base plate.

19. The device of claim 16, wherein the recess extends inwardly into the base element from a periphery of the base element.

20. The device of claim 16, wherein the recess has a cruciform shape.

21. The device of claim 16, wherein the recess is disposed within a material portion extending outwardly from the base plate.

22. The device of claim 16, wherein the recess includes a constriction, and the drive element ends are secured by guiding a portion of the drive element ends through the constriction.

23. The device of claim 16, wherein the recess is configured such that the drive element ends are held in place via frictional forces.

24. The device of claim 16, wherein the securing element is configured such that the drive element ends can be repeatedly removed and re-secured.

25. The device of claim 16, wherein the drum is configured to accommodate a plurality of drive elements.

26. The device of claim 25, further comprising a plurality of securing elements, at least one of the plurality of securing elements corresponding to each of the plurality of drive elements.

27. The device of claim 25, wherein two drive element ends protrude from the drum, and the device includes two securing elements.

28. The device of claim 27, wherein the two securing elements are disposed opposite each other relative to an axis of symmetry through the base element.

29. The device of claim 16, wherein the securing element is spaced at least about 10 millimeters from the drum take-off.

30. The device of claim 16, wherein the drive element ends comprise cable or wire.

31. The device of claim 16, wherein the base element comprises plastic or metal.

32. A method of transporting and attaching a device configured for use in a window lifting unit, the device comprising a base element, a drum configured to be connected to the base element and securing elements, the method comprising:
winding a drive element onto the drum;
connecting the wound-up drum to the base element;
securing ends of the drive element into recesses of the securing elements;
transporting the device;
attaching the device to a door module; and
removing the ends of the drive element from the recesses of the securing elements.

33. The method of claim 32, wherein the step of securing the drive elements into recesses of the securing elements is performed by an automatic machine.

34. The method of claim 32, wherein the step of removing the drive elements from the recesses of the securing elements is performed by an automatic machine.
